(19) United States
(12) Patent Application Publication
(10) Pub. No.: US 2021/0097340 A1
(43) Pub. Date: Apr. 1, 2021

(54) Teaching Data Creation Device and Image Classification Device

(71) Applicant: SUZUKI MOTOR CORPORATION, Hamamatsu-shi (JP)

(72) Inventor: Yuichi UMEZANE, Hamamatsu-shi (JP)

(21) Appl. No.: 17/035,653

(22) Filed: Sep. 28, 2020

(30) Foreign Application Priority Data
Sep. 30, 2019 (JP) 2019-180165

(51) Int. Cl. G06K 9/62; G06K 9/00

(52) U.S. Cl. CPC G06K 9/6256; G06K 9/6267; G06K 9/00825

(57) ABSTRACT

A teaching data creation device 100 includes an acquisition unit 110 configured to acquire an image of a vehicle in the surroundings, the image being captured by a vehicle-mounted camera; a reception unit 120 configured to receive correct answer data for supervised learning, in relation to the vehicle shown in the image acquired by the acquisition unit; and a creation unit 130 configured to create teaching data for supervised learning, the teaching data being a combination of the image acquired by the acquisition unit and the correct answer data received by the reception unit. The reception unit receives, as the correct answer data, a type of the vehicle shown in the image, and a position and a size of a region, in the image, in which the vehicle is shown.

### FIELD OF THE INVENTION

The present invention relates to a teaching data creation device and to an image classification device.

### DISCUSSION OF THE RELATED ART

JP 2010-286926 A describes a surroundings-monitoring device that is mounted in a mobile object such as a vehicle, and that monitors target objects in the surroundings of the mobile object. The surroundings monitoring device includes an image acquisition unit configured to acquire images of the surroundings of the mobile object in time series, and a time-series information calculation unit configured to calculate a movement component from time-series images acquired by the image acquisition unit. As the movement component, a two-dimensional optical flow is cited.

### SUMMARY OF INVENTION

When any object is detected by a device such as the surroundings monitoring device using an optical flow, the object is normally unidentified to the device. Accordingly, an alarm or a call for attention that is issued on the basis of a detection result regarding the object may possibly be false. Moreover, an amount of calculation necessary to calculate the optical flow tends to be enormous in order to achieve increased detection accuracy.

An object of the present invention is to efficiently detect a vehicle that is present in the surroundings of a certain vehicle, by using a machine learning technique.

To achieve the object described above, a teaching data creation device includes an acquisition unit configured to acquire an image of a vehicle in the surroundings, the image being captured by a vehicle-mounted camera; a reception unit configured to receive correct answer data for supervised learning, in relation to the vehicle shown in the image acquired by the acquisition unit; and a creation unit configured to create teaching data for supervised learning, the teaching data being a combination of the image acquired by the acquisition unit and the correct answer data received by the reception unit, where the reception unit receives, as the correct answer data, the type of the vehicle shown in the image, and a position and a size of a region, in the image, in which the vehicle is shown.

According to the present invention, a vehicle that is present in the surroundings of a certain vehicle may be efficiently detected using a machine learning technique.

### BRIEF DESCRIPTION OF THE DRAWINGS

FIG. 1 is an explanatory diagram showing a traveling state of vehicles.

FIG. 2 is an explanatory diagram showing an image captured by a vehicle-mounted camera.

FIG. 3 is an explanatory diagram showing an example image for supervised learning.

FIG. 4 is an explanatory diagram showing an example of a functional configuration of a teaching data creation device.

FIG. 5 is an explanatory diagram showing an example of a computer hardware configuration of the teaching data creation device.

FIG. 6 is an explanatory diagram of a vehicle-mounted system.

### DETAILED DESCRIPTION OF THE DRAWINGS

Hereinafter, the present invention will be described with reference to an embodiment illustrated in the drawings. However, the present invention is not limited to the embodiment described below.

The embodiment described below relates to a technology for supporting safe driving of a vehicle. Specifically, the present embodiment relates to a technology for allowing presence to be easily grasped of a vehicle (a following vehicle or the like) in the surroundings of a vehicle (subject vehicle), such as a four-wheeled vehicle, in a case in which the vehicle (subject vehicle) is traveling on a road, such as an expressway.

Examples of a state of a following vehicle are given below.

(1) Traveling in a lane adjacent to a traveling lane of the subject vehicle, and trying to overtake the subject vehicle.

(2) Traveling in the same lane as the subject vehicle while moving closer to the subject vehicle.

(3) Traveling in the same lane as the subject vehicle while maintaining an inter-vehicle distance to the subject vehicle.

As described above, the problem of a conventional technique is that a detected object is unidentified to the device that performed detection. Accordingly, the embodiment described below is based on a viewpoint that, if a process of directly recognizing a detected object is incorporated in a process after collection of raw data, an overall flow of processes is simplified, and false alarms based on erroneous detections may be reduced. In the present embodiment, object recognition based on machine learning is adopted in the process after collection of raw data.

In applying machine learning, “manner of learning” and “method of using result at the time of determination” are important.

1. Manner of Learning

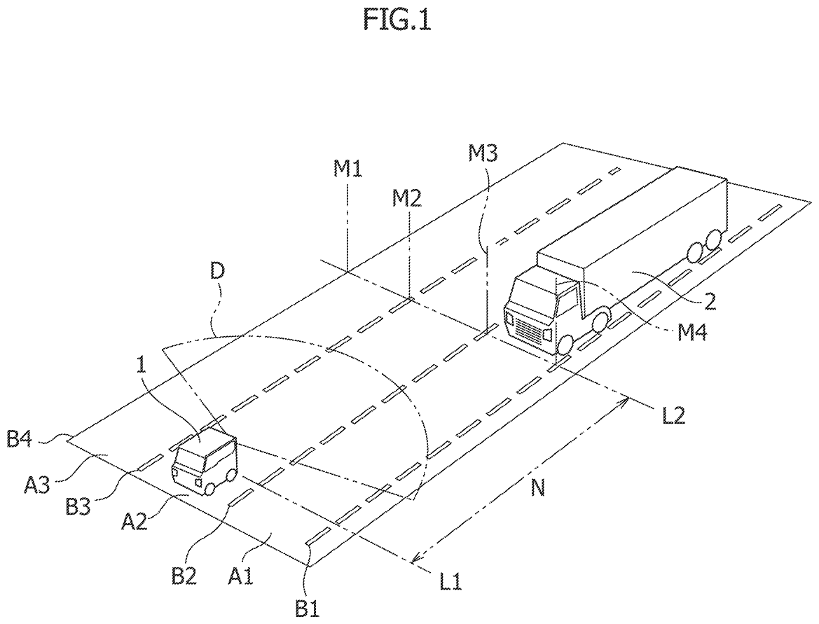

FIG. 1 shows an example of a traveling state on a flat road having three lanes A1 to A3. A first lane A1, a second lane A2, and a third lane A3 are all straight and have the same traveling direction. The second lane A2 is positioned at the right side of the first lane A1 in the traveling direction, and the third lane A3 is positioned at the right side of the second lane A2 in the traveling direction.

In the drawing, reference sign B1 denotes a boundary on a left side of the first lane A1 in the traveling direction, and reference sign B2 denotes a boundary between the first lane A1 and the second lane A2. Furthermore, reference sign B3 denotes a boundary between the second lane A2 and the third lane A3, and reference sign B4 denotes a boundary on a right side of the third lane A3 in the traveling direction.

A first vehicle 1 is a light vehicle, for example, and is traveling in the second lane A2. A second vehicle 2 is a truck, for example, and is traveling in the first lane A1 behind the first vehicle 1.

A camera is attached to a rear portion of the first vehicle 1, the camera being for capturing a rearward view of the vehicle. A range that is shown in an image when capturing is performed by the camera is indicated by reference sign D.

In FIG. 1, straight lines L1 and L2, and straight lines M1 to M4 are virtual. First, the straight line L1 passes through a point, on the road, immediately below a rear end portion of the first vehicle 1, and extends in a vehicle width direction. The straight line L2 passes through a point, on the road, immediately below a front end portion of the second vehicle 2, and extends in a vehicle width direction. A distance between the straight line L1 and the straight line L2 is indicated by a reference sign N.

The straight line M1 passes through an intersection point of the straight line L2 and the boundary B4, and extends in a direction of gravity, and the straight line M2 passes through an intersection point between the straight line L2 and the boundary B3, and extends in the direction of gravity. Furthermore, the straight line M3 passes through an intersection point of the straight line L2 and the boundary B2, and extends in the direction of gravity, and the straight line M4 passes through an intersection point of the straight line L2 and the boundary B1, and extends in the direction of gravity.

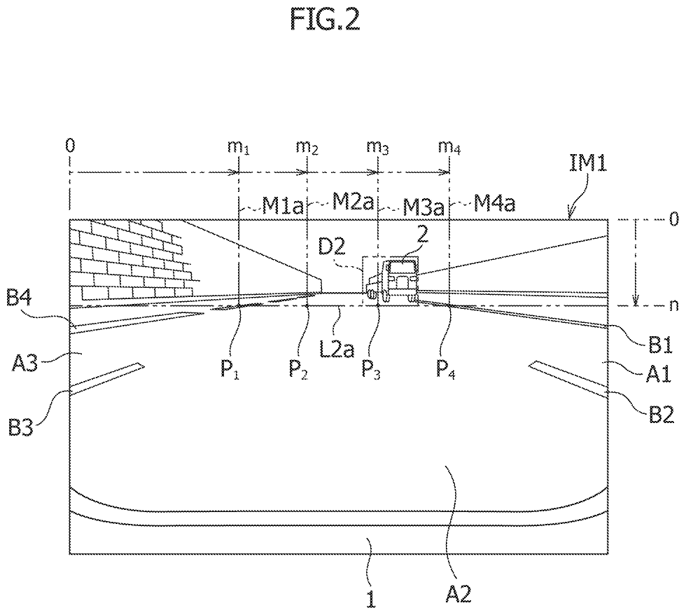

FIG. 2 shows a rectangular image IM1 obtained by the camera. The lanes A1 to A3, the boundaries B1 to B4, and the second vehicle 2 are shown in the image. In this image, reference sign D2 denotes a rectangular region that includes a region where the second vehicle 2 is shown, and that has the smallest size. Of four sides of the rectangular region, two sides extend in a horizontal direction in the image IM1, and other two sides extend in a vertical direction in the image IM1.

A virtual straight line L2a passes through a lower left vertex and a lower right vertex of the region D2, and extends in the horizontal direction in the image IM1. In an image coordinate system having an origin at a pixel at an upper left corner of the image IM1, the straight line L2a is an n-th row pixel. Here, the ordinal number n is a natural number. The straight line L2a corresponds to the straight line L2 in FIG. 1, and the ordinal number n corresponds to the distance N in FIG. 1. The smaller the distance N, the greater the ordinal number n, and the greater the distance N, the smaller the ordinal number n.

A virtual straight line M1a passes through an intersection point P₁ of the boundary B4 and the straight line L2a in the image, and extends in the vertical direction in the image. The straight line M1a is an m₁-st column pixel in the image coordinate system, and corresponds to the straight line M1 in FIG. 1. Here, the ordinal number m₁ is a natural number.

A virtual straight line M2a passes through an intersection point P₂ of the boundary B3 and the straight line L2a in the image, and extends in the vertical direction in the image. The straight line M2a is an m₂-nd column pixel in the image coordinate system, and corresponds to the straight line M2 in FIG. 1. Here, the ordinal number m₂ is a natural number.

A virtual straight line M3a passes through an intersection point P₃ of the boundary B2 and the straight line L2a in the image, and extends in the vertical direction in the image. The straight line M3a is an m₃-rd column pixel in the image coordinate system, and corresponds to the straight line M3 in FIG. 1. Here, the ordinal number m₃ is a natural number.

A virtual straight line M4a passes through an intersection point P₄ of the boundary B1 and the straight line L2a in the image, and extends in the vertical direction in the image. The straight line M4a is an m₄-th column pixel in the image coordinate system, and corresponds to the straight line M4 in FIG. 1. Here, the ordinal number m₄ is a natural number.

With respect to the ordinal numbers m₁ to m₄, m₁<m₂<m₃<m₄ is established.

When creating teaching data with the image IMI as an example image, information about the region D2 where the second vehicle 2 is shown (such as a position or a size in the image) is taken as correct answer data. When a target image to be classified is input in a learned model that is learned using the teaching data created in such a manner, pixel values of the rectangular region are output as a result at the time of extracting the truck from the target image. A lower end of such a so-called determination region (a rectangular region on a front side of the truck) indicates a front end of the truck on the road.

2. Method of using Result at the Time of Determination

Because a position and an angle of the camera of the subject vehicle, and a relationship between the subject vehicle and the direction of the lane on the road are known, there is a one-to-one correspondence relationship between the row pixels and the column pixels in the image IM1 shown in FIG. 2, and a distance in an actual space shown in FIG. 1.

In the target image to be classified, an actual distance between the subject vehicle and the truck (the distance N in FIG. 1) may be determined by a position, in the image, of the lower end line L2a of the determination region determined to be the truck. Furthermore, the traveling lane of the determined vehicle (the same or adjacent lane of the lane of the subject vehicle) may be determined.

The underlying concept is that, because an in-image position where a following vehicle is to appear is learned, appearance of a vehicle at the position is waited for at the time of classification of a target image.

Due to “1. Manner of Learning” and “2. Method of Using Result at the Time of Determination” described above, an identification process used in the conventional technique becomes unnecessary, and a mobile object may be determined at an early stage in the process, and transition to determination of safety/unsafety in relation to the subject vehicle may be performed. Compared to the conventional technique, a good balance between reduction in processing time and increase in detection accuracy may be achieved.

The embodiment described below may be divided into three stages. In a first stage, teaching data is created. In a second stage, learning is performed using the teaching data created in the first stage, and a learned model is created. In a third stage, classification of a target image to be classified is performed using the learned model created in the second stage.

First Stage: Creation of Teaching Data

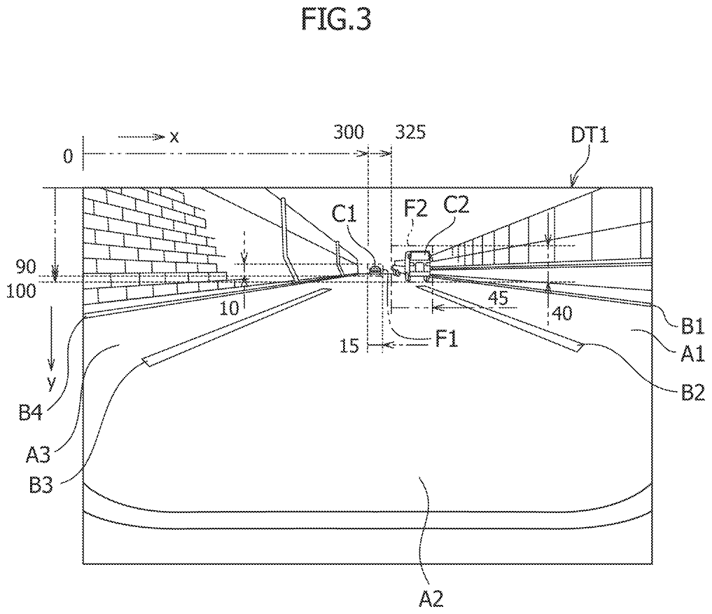

FIG. 3 shows an example image DT1 that is an example for supervised learning. Correct answer data is given to the example image, and teaching data that is a combination of the example image and the correct answer data is created. In the following, creation of teaching data using the example image will be specifically described.

Additionally, the example image DT1 is a still image. The example image DT1 may be a still image that is extracted from a moving image.

Additionally, the correct answer data is referred to also as a label or a tag. A process of giving teaching data to the example image is referred to also as labelling, tagging, or annotation.

Like the image IM1 shown in FIG. 2, the example image DT1 is an image of a vehicle in the surroundings that is captured by the vehicle-mounted camera of the first vehicle 1 traveling on the lane A2. A first object C1 and a second object C2 are shown in the example image DT1. A reference sign F1 denotes a rectangular region that includes a region where the first object C1 is shown, and that has a smallest size. Of four sides of the rectangular region, two sides extend in a horizontal direction in the image, and other two sides extend in a vertical direction in the image. A reference sign F2 denotes a rectangular region that includes a region where the second object C2 is shown, and that has a smallest size. Of four sides of the rectangular region, two sides extend in the horizontal direction in the image, and other two sides extend in the vertical direction in the image.

Correct answer data that is given in relation to the first object is as follows.

Type: passenger vehicle

In-image size: 15, 10

In-image position: 300, 90

Distance: 100 meters

Lane: same lane as subject vehicle (center lane)

Correct answer data that is given in relation to the second object is as follows.

Type: truck

In-image size: 45, 40

In-image position: 325, 100

Distance: 80 meters

Lane: lane on left side of lane of subject vehicle in traveling direction

In the correct answer data mentioned above, “type” is the type of a vehicle, and “passenger vehicle”, “truck”, and “bus” may be set as candidates for the type, for example. A classification destination of image classification in the third stage described later changes depending on how the candidate is set, and thus, the candidate may be set according to a desired classification destination. In the present example, the type of the first object is “passenger vehicle”, and the type of the second object is “truck”.

“In-image size” indicates sizes, in the horizontal direction and the vertical direction, of the rectangular regions F1 and F2, in the image, where the first object and the second object are shown, respectively. In the case of the first object, the size in the horizontal direction is 15 pixels, and the size in the vertical direction is 10 pixels. In the case of the second object, the size in the horizontal direction is 45 pixels, and the size in the vertical direction is 40 pixels.

“In-image position” indicates coordinates of a pixel at a lower left corner of each of the rectangular regions F1 and F2. In the case of the first object, an x-coordinate is 300, and a y-coordinate is 90. In the case of the second object, the x-coordinate is 325, and the y-coordinate is 100.

“Distance” is a distance from the subject vehicle to each object (the distance N in FIG. 1). A straight line passing through a lower end of the rectangular region F1 where the first object is shown corresponds to a 90th row pixel. Accordingly, “distance” from the subject vehicle to the first object is 100 meters. Furthermore, a straight line passing through a lower end of the rectangular region F2 where the second object is shown corresponds to a 100th row pixel. Accordingly, “distance” from the subject vehicle to the second object is 80 meters.

For example, a vehicle at the position that is 100 meters from the subject vehicle is captured, and a row pixel number of a lower end of a region, in the captured image, where the vehicle is shown is obtained in advance. “Distance” may be obtained for the first object and the second object with reference to such a row pixel number.

“Lane” is a lane where each vehicle is traveling. In the case of the first object, because the distance is 100 meters and the in-image position is 300, 90, “lane” is “same lane as subject vehicle”. In the case of the second object, because the distance is 80 meters and the in-image position is 325, 100, “lane” is “lane on left side of lane of subject vehicle in traveling direction”.

As the correct answer data, five items of “type”, “in-image size”, “in-image position”, “distance”, and “lane” are cited, but these are merely examples. Items may be narrowed down to three, namely, “type”, “distance”, and “lane”, for the correct answer data. Alternatively, items may be narrowed down to three, namely, “type”, “in-image size”, and “in-image position”, for the correct answer data. That “in-image size” and “in-image position”, and “distance” and “lane” are in correspondence relationship is described above with reference to FIG. 1.

A case in which the correct answer data includes three items of “type”, “distance”, and “lane” will be further described. Possible specific data for each item is indicated in Table 1 below. First, three patterns of “passenger vehicle”, “truck”, and “two-wheeled vehicle” are given as specific data for “type”, for example. As specific data for “lane”, three patterns of “same lane as subject vehicle”, “lane that is adjacent on the right”, and “lane that is adjacent on the left” are given, for example. As specific data for “distance”, four patterns of “10 m”, “50 m”, “80 m”, and “100 m” are given, for example. That is, 3×3×4=36 types of correct answer data may be prepared.

TABLE 1
Possible Specific Data for Each Item of Correct Answer Data

| Type of Vehicle | Passenger Vehicle | Truck | Two-Wheeled Vehicle | |
|---|---|---|---|---|
| Lane Position | Same Lane as | Lane That is | Lane That is | |
| | Subject Vehicle | Adjacent on the | Adjacent on the | |
| | | Right | Left | |
| Distance from | 10 m | 50 m | 80 m | 100 m |
| Subject Vehicle | | | | |

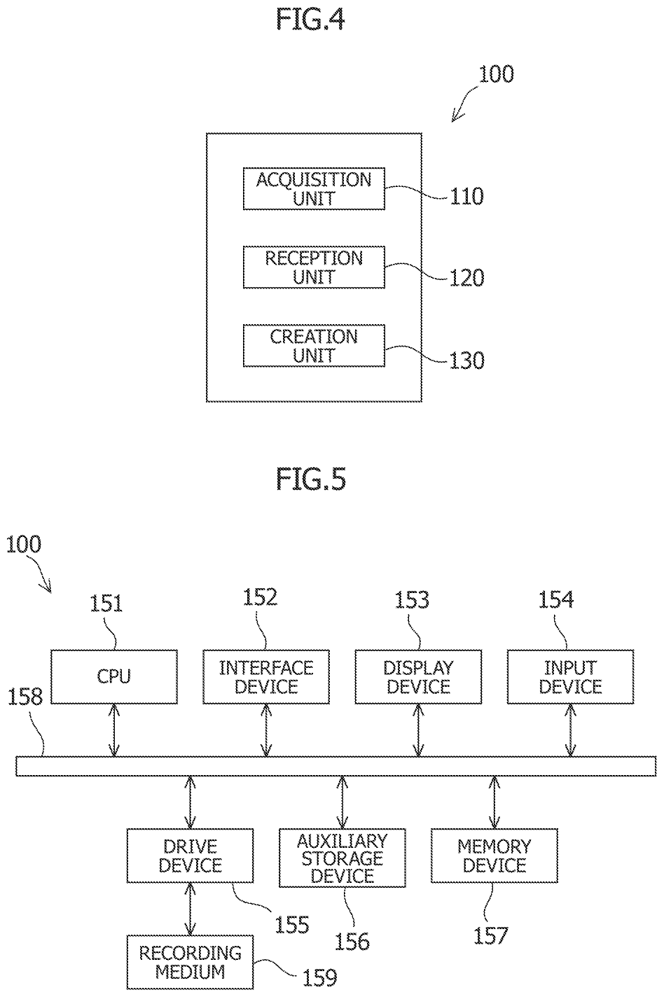

Creation of the teaching data is performed by a teaching data creation device 100 shown in FIG. 4. The teaching data creation device 100 includes an acquisition unit 110, a reception unit 120, and a creation unit 130.

The acquisition unit 110 is configured to acquire the image DT1 that is captured by the vehicle-mounted camera and where a vehicle different from the subject vehicle is shown. The reception unit 120 is configured to receive correct answer data that is manually input in relation to the vehicle that is shown in the image DT1 that is acquired by the acquisition unit 110. The correct answer data regarding the image DT1 is as described above. The creation unit 130 is configured to create teaching data that is a combination of the image DT1 that is acquired by the acquisition unit 110 and the correct answer data that is received by the reception unit 120.

FIG. 5 shows an example of a computer hardware configuration of the teaching data creation device 100. The teaching data creation device 100 includes a CPU 151, an interface device 152, a display device 153, an input device 154, a drive device 155, an auxiliary storage device 156, and a memory device 157, and these are interconnected by a bus 158.

Programs for implementing functions of the teaching data creation device 100 are provided by a recording medium 159 such as a CD-ROM. When the recording medium 159 recording the programs is set in the drive device 155, the programs are installed in the auxiliary storage device 156 from the recording medium 159 via the drive device 155. Alternatively, installation of the programs does not necessarily have to be performed by the recording medium 159, and may be performed via a network. The auxiliary storage device 156 is configured to store the installed programs, and also, store necessary files, data, and the like.

When a program start command is issued, the memory device 157 is configured to read a program from the auxiliary storage device 156, and store the program. The CPU 151 is configured to implement a function of the teaching data creation device 100 according to the program stored in the memory device 157. The interface device 152 is configured to be used as an interface for connecting to another computer via a network. The display device 153 is configured to display a graphical user interface (GUI) or the like according to a program. The input device 154 is a keyboard and a mouse, for example.

Second Stage: Creation of Learned Model

In the second stage, learning is performed using the teaching data that is created in the first stage. A learned model is thereby created. A method of creating a learned model from teaching data is already known, and a known method is used in the present embodiment.

Third Stage: Classification of Target Image

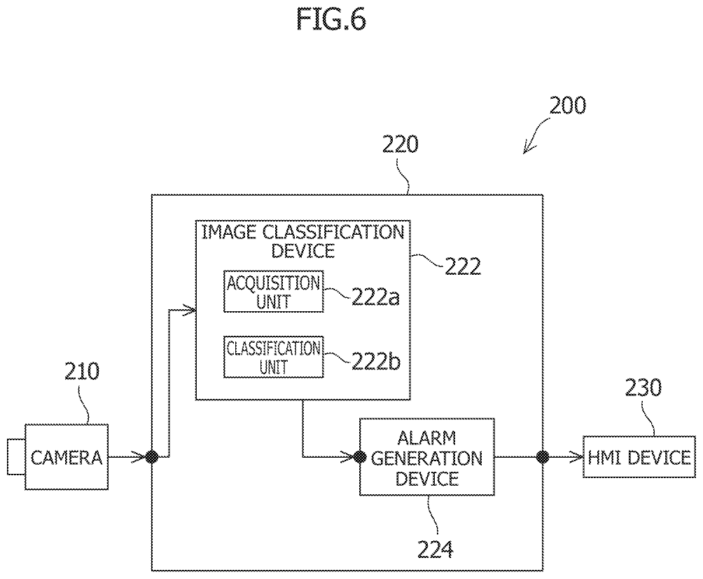

In the third stage, classification of a target image to be classified is performed using the learned model that is created in the second stage. The third stage is performed by a vehicle-mounted system 200 shown in FIG. 6. The vehicle-mounted system 200 further issues an alarm to a driver of the vehicle where the system is mounted, according to a classification result of the target image.

The vehicle-mounted system 200 includes a vehicle-mounted camera 210, a controller 220, and a human machine interface (HMI) device 230. The controller 220 includes an image classification device 222 including an acquisition unit 222a and a classification unit 222b, and an alarm generation device 224.

The vehicle-mounted camera 210 is configured to capture a rearward view of the vehicle where the vehicle-mounted system 200 is mounted. A target image that is acquired by the vehicle-mounted camera 210 is transmitted to the image classification device 222 in the controller 220.

The acquisition unit 222a in the image classification device 222 is configured to acquire the target image transmitted from the vehicle-mounted camera 210, and to transmit the image to the classification unit 222b. The learned model created in the second stage is incorporated in the classification unit 222b. The classification unit 222b is configured to classify the target image transmitted from the acquisition unit 222a, by using the learned model, according to the type of the vehicle shown in the target image, the lane in which the vehicle is located, and the distance between the vehicle and the subject vehicle. The classification destination is one of patterns of correct answer data set in the first stage. In a case in which a plurality of vehicles is shown in one target image, classification is performed for each vehicle.

The classification unit 222b determines whether the target image matches an already learned model of correct answer data. In a case in which 36 patterns of correct answer data are prepared in the first stage, with which pattern, among the 36 patterns, each vehicle shown in the target image matches, is determined in the third stage. In a case in which no pattern is matched, it is determined that no vehicle is shown in the target image. The underlying concept is that the in-image position in which a following vehicle is to appear is learned in the first stage and the second stage, and appearance of a vehicle at the learned in-image position is waited for in the third stage.

A classification result from the image classification device 222 is input in the alarm generation device 224. The alarm generation device 224 is configured to generate an alarm for the driver of the vehicle on the basis of the input classification result. The alarm is issued to the driver of the vehicle via the HMI device 230. As the HMI device, a display device or an audio output device may be cited, for example.

In the case in which the target image is determined by the classification unit 222b to match one of the patterns of the correct answer data, the type of the vehicle, the lane position, and the distance from the subject vehicle corresponding to the pattern are displayed by the HMI device 230.

Additionally, a computer hardware configuration of the vehicle-mounted system 200 may also adopt the configuration shown in FIG. 5.

As described above, in the first stage, teaching data having, as the correct answer data, the type of a vehicle, and the position and the size of the region where the vehicle is shown, is created, and in the second stage, a learned model based on the teaching data is created. In the third stage, classification of a target image is performed using the learned model. In the third stage, a mobile object in the target image may be recognized as a vehicle. Accordingly, unlike the conventional technique, filtering for removing objects that are not detection targets (such as static objects such as utility poles and buildings, shadows cast on a road surface by buildings, and the like) from detection targets is not necessary. If the detection accuracy equivalent to that of the conventional technique is sufficient, a processing time may be reduced compared to the conventional technique. Alternatively, if the processing time may be equivalent to that of the conventional technique, the detection accuracy may be increased compared to the conventional technique.

Because the type of the detected vehicle is also detected, the driver may be notified of what type of vehicle is approaching. That is, more accurate information may be provided to avoid dangers.

Furthermore, a mark may be displayed superimposed on a detected mobile object, on a monitor outputting a video of the vehicle-mounted camera during traveling. That is, information that can be more easily grasped may be provided.

In the embodiment described above, the vehicle-mounted camera is a rear camera that is attached to a rear portion of a vehicle and that is configured to capture a rearward view of the vehicle. But such a case is not a limitation. As the vehicle-mounted camera, a side camera that is attached to a side portion of a vehicle and that is configured to capture a lateral view of the vehicle may be used, or a front camera that is attached to a front portion of a vehicle and that is configured to capture a forward view of the vehicle, may be used. However, to maximize the effect of learning, a camera configured to capture an example image and a camera configured to capture a target image as a target of classification are desirably of a same type. For example, if the former is a front camera, the latter is desirably also a front camera.

In the case in which a front camera is used, a function of detecting a person at a time of traveling at a low speed may be implemented. In the case in which a side camera is used, a function of detecting a vehicle traveling side by side with the subject vehicle may be implemented. Furthermore, cameras at front, back, left, and right of a vehicle may be coordinated with one another to implement a function of detecting a vehicle that is present in the surroundings of the subject vehicle.

One or more of the following pieces of information may be added to the correct answer data. This allows an image to be classified according to the added information.
Information about whether capturing of an example image was performed during day or night.
Information about weather at the time of capturing of an example image.
Information about whether headlights of a vehicle shown in an example image are on or off.
Information about slope of a road shown in an example image.

Teaching data creation described with reference to FIG. 4 also has an aspect of a method and an aspect of a computer program, in addition to an aspect of a device. The same can be said for image classification described with reference to FIG. 6.

Heretofore, embodiments of the present invention have been described, but the present invention is not limited to the embodiments described above, and various modifications and alterations may be made on the basis of technical ideas of the present invention.

1. A teaching data creation device comprising:
an acquisition unit configured to acquire an image of a vehicle in surroundings, the image being captured by a vehicle-mounted camera;
a reception unit configured to receive correct answer data for supervised learning, in relation to the vehicle shown in the image acquired by the acquisition unit; and
a creation unit configured to create teaching data for supervised learning, the teaching data being a combination of the image acquired by the acquisition unit and the correct answer data received by the reception unit,
wherein the reception unit is configured to receive, as the correct answer data, a type of the vehicle shown in the image, and a position and a size of a region, in the image, in which the vehicle is shown.

2. An image classification device comprising:
an acquisition unit configured to acquire a target image to be classified, the target image being captured by a vehicle-mounted camera; and
a classification unit configured to classify the target image according to a type of a vehicle shown in the target image, a lane in which the vehicle is located, and a distance between the vehicle and a subject vehicle, by using a learned model learned using teaching data created by the teaching data creation device according to claim 1.

3. An image classification method comprising:
acquiring a target image to be classified, the target image being captured by a vehicle-mounted camera; and
classifying the target image according to a type of a vehicle shown in the target image, a lane in which the vehicle is located, and a distance between the vehicle and a subject vehicle, by using a learned model learned using teaching data created by the teaching data creation device according to claim 1.
